(19) United States
(12) Patent Application Publication
(10) Pub. No.: US 2024/0152855 A1
(43) Pub. Date: May 9, 2024

(54) INFORMATION-BASED INTELLIGENT QUALITY TRACEABILITY SYSTEM FOR FRESH MILK

(71) Applicants: Qi YANG, Yinchuan (CN); Ming HAN, Yinchuan (CN); Ningxia Veterinary Medicine and Feed Supervision Institute, Yinchuan (CN); Ningxia Boruite Technology Development Co., Ltd, Yinchuan (CN); Yinchuan Fangda Electronic System Engineering Co., Ltd, Yinchuan (CN)

(72) Inventors: Qi Yang, Yinchuan (CN); Ming HAN, Yinchuan (CN); Weihua LIU, Yinchuan (CN); Junhua YANG, Yinchuan (CN); Juan ZHAO, Yinchuan (CN); Xin LI, Yinchuan (CN); Wen ZHANG, Yinchuan (CN); Yating DENG, Yinchuan (CN)

(21) Appl. No.: 18/205,214

(22) Filed: Jun. 2, 2023

(30) Foreign Application Priority Data
Oct. 28, 2022 (CN) 202211331192.5

(51) Int. Cl. G06Q 10/0832

(52) U.S. Cl. CPC G06Q 10/0832

(57) ABSTRACT

Disclosed in the present disclosure is an information-based intelligent quality traceability system for fresh milk, which includes a database module configured to store information of the system, a data encryption module configured to encrypt obtained information, an enterprise information module, a raw material information module, a first measurement module, a destruction information module, a transportation information module, a second measurement module, a processing information module, and a delivery information module. Each information module obtains information, a data decryption module is configured to decrypt obtained information, a vehicle condition analysis module is configured to analyze a relation between a vehicle running condition and product quality, and a data analysis module is configured to analyze the data of the system.

### CROSS REFERENCE TO RELATED APPLICATION

This patent application claims the benefit and priority of Chinese Patent Application No. 202211331192.5, filed with the China National Intellectual Property Administration on Oct. 28, 2022, the disclosure of which is incorporated by reference herein in its entirety as part of the present application.

### TECHNICAL FIELD

The present disclosure relates to the field of big data information, and particularly relates to an information-based intelligent quality traceability system for fresh milk.

### BACKGROUND

Currently, production data on fresh milk in cities and counties of Ningxia is inaccurate, and dairy processing enterprises are deficient in fresh milk product processing data. Further, information about fresh milk products transported to other provinces, information about processing of unqualified products, and information about dairy transport are deficient. Apart from information deficiency, the information may also be false-reported, concealed or falsified. Farms and dairies throughout the cities and counties can only report the production data when required by the regulatory organizations, without verifying the authenticity and accuracy of the reported data. Further, the production data on fresh milk from cities, counties and enterprises can only be viewed after reported level by level, instead of being viewed immediately. In this way, supervision of the market by the regulatory organizations will be affected over time, and chain quality traceability cannot be completed once the fresh milk on the market has a quality problem. Moreover, the dairy processing enterprises transports fresh raw milk produced locally to processing enterprises in other provinces for processing, which affects local economic development and confuses data of local breeding enterprises and production and processing data of fresh milk. Accordingly, the industrial development is stopped from being factually and effectively reflected.

### SUMMARY

An objective of the present disclosure is to provide an information-based intelligent quality traceability system for fresh milk, to solve the problems in the background.

In order to solve the above technical problems, the present disclosure provides the follow technical solution: an information-based intelligent quality traceability system for fresh milk includes a database module, a data encryption module, an enterprise information module, a raw material information module, a first measurement module, a destruction information module, a transportation information module, a second measurement module, a processing information module, a delivery information module, a vehicle condition analysis module, a data decryption module and a data analysis module, where the database module is configured to store all data in the system; the data encryption module is configured to encrypt the data generated in the system; the raw material information module is configured to obtain information about raw fresh milk produced daily; the enterprise information module is configured to obtain information about a farm and an individual household; the first measurement module is configured to measure fresh milk conveyed from the farm and the individual household daily; the destruction information module is configured to obtain information about fresh milk that does not comply with national standards during first measurement; the transportation information module is configured to obtain transportation information about a milk tanker; the second measurement module is configured to measure fresh milk transported to a dairy processing enterprise; the processing information module is configured to obtain data on processing of the fresh milk by the dairy processing enterprise; the delivery information module is configured to obtain data of processed milk after delivery; the vehicle condition analysis module is configured to analyze a road driving condition of a vehicle; the data decryption module is configured to inspect encrypted information; and the data analysis module is configured to analyze data in a database.

Further, the data encryption module includes a hash encryption module, a storage node generation module and a storage node encryption module; the hash encryption module is configured to generate an original hash character string corresponding to data generated in each module; the storage node generation module is configured to generate a random node position for storing the original hash character string when the original hash character string is generated; and the storage node encryption module is configured to encrypt the node position for storing the original hash character string by means of a built-in public key of the system, and store node encryption information in the database. All the data in the system are encrypted by means of data encryption, so as to prevent illegal personnel from falsifying the data in the system, which results in that unqualified products flow into the market and jeopardize the interests of consumers, or that defective products are missed as entire traceability has problems due to wrong data.

Further, the enterprise information module is configured to obtain production license information, business license information and production scale information about each farm and individual household, store the information in the database, match a time limit of each license with a system time, mark an enterprise which has an expired and invalid license, warn a supervisor, and simultaneously generate an enterprise information code C₁, where node encryption information about enterprise information about the farm and the individual household is directly obtained by means of the enterprise information code C₁. Enterprise information is collected to strengthen management and control over raw milk sources, eliminate unqualified milk sources, and reduce potential safety hazards of processed milk industry from the source.

Further, the raw material information module is configured to obtain the information about raw fresh milk produced daily including a source of production of a batch of raw milk A, a production time of the raw milk A, and quality of the raw milk A, store the information in the database, and simultaneously generate a raw material information code C₂, where node encryption information about the information about the raw milk A, is directly obtained by means of the raw material information code C₂, and the raw milk A, is any batch of raw milk.

Further, the first measurement module is configured to measure each quality index Oₙ of raw milk A and compare each quality index Oₙ of the raw milk A with a national standard index Iₙ; and when each quality index Oₙ of the raw milk A complies with the national standard Iₙ, the raw milk A is allowed to be transported out from a production place, each quality index is stored in a database, a first measurement information code C₃ is simultaneously generated, where node encryption information about each quality index Oₙ of the raw milk A is directly obtained by means of the first measurement information code C₃. The quality indexes Oₙ of the raw milk A include: a protein measurement value O₁, a fat measurement value O₂, a microorganism measurement value O₃, a freezing point measurement value O₄, a relative density measurement value O₅, a non-fat milk solid measurement value O₆, an acidity measurement value O₇ and an adulteration measurement value O₈. The national standards Iₙ include: a protein measurement value I₁≥2.8, a fat measurement value I₂≥3.1, a microorganism measurement value I₃≤200, −0.56≤ a freezing point measurement value I₄≤−0.5, a relative density measurement value I₅≥1.027, a non-fat milk solid measurement value I₆≥8.1, 12≤ an acidity measurement value I₇≤18 and an adulteration measurement value I₈=0. The quality indexes Oₙ are measured and compared with the national standards Iₙ, so as to guarantee raw milk quality. The indexes Oₙ of raw milk are recorded, so as to facilitate study of data and investigation of subsequent problems.

Further, the destruction information module is configured to obtain each quality index Oₙ of raw milk B with a quality index Oₙ not complying with the national standard Iₙ, a destruction mode of the raw milk B, and a destruction place of the raw milk B, store destruction information in the database, send the destruction information to a supervisor to remind the supervisor to supervise a destruction process, and simultaneously generate a destruction information code C_{d}, where node encryption information about each quality index Oₙ of the raw milk B, the destruction mode of the raw milk B and the destruction place of the raw milk B is directly obtained by means of the destruction information code C_{d}, and the raw milk B is any batch of raw milk with unqualified quality indexes; and the transportation information module is configured to obtain transportation information about the raw milk A during transportation from a production place to a processing enterprise, including vehicle information, driver information, vehicle positioning, a milk tank temperature and starting and ending times of transportation, store the transportation information about the raw milk A in the database, and generate a transportation information code C₄, so as to directly obtain the transportation information about the raw milk A from the database by means of the transportation information code C₄. The destruction information about the raw milk B that does not comply with the national standards Iₙ is recorded, and each batch of unqualified raw milk is accurately tracked, to prevent the unqualified raw milk from entering the market and influencing the safety of consumers. Transportation information about raw milk during transportation from a production place to a processing enterprise is recorded, such that whether an unexpected situation occurred during transportation and an influence on the raw milk may be analyzed. The data is recorded, so as to improve the raw milk quality and reliability of a source effectively, and a problem source may be conveniently located when problems occurs later.

Further, the second measurement module is configured to measure each quality index Oₙ of the raw milk A and compare each quality index Oₙ of the raw milk A with a national standard index Iₙ; and when each quality index Oₙ of the raw milk A complies with the national standard Iₙ, the raw milk A is allowed to enter the processing enterprise from a transport vehicle, each quality index is stored in the database, and a second measurement information code C₅ is generated simultaneously, where node encryption information about each quality index Oₙ of the raw milk A is directly obtained by means of the second measurement information code C₅. Each quality index Oₙ of raw milk before entering a processing enterprise is measured, so as to not only guarantee the quality of the raw milk before entering the processing enterprise, but also timely find problems during loading and transportation of the raw milk, and further to facilitate investigation of the problems.

Further, the processing information module is configured to obtain processing information about raw milk A in a processing enterprise, including a processing time, a processing temperature, a processing apparatus and a processing batch, store the processing information in the database, and simultaneously generate a processing information code C₆ where node encryption information about the processing information about the raw milk A is directly obtained by means of the processing information code C₆; and the delivery information module is configured to obtain delivery information about each product obtained after the raw milk A is processed in the processing enterprise, including a delivery time, a delivery batch, a delivery transportation direction and a number of products, and store the delivery information in the database, and simultaneously generate a delivery information code C₇ for each product obtained after the raw milk A is processed, where node encryption information about the delivery information about each product obtained after the raw milk A is processed in the processing enterprise is directly obtained by means of the factory information code C₇. Raw milk processing information in a processing enterprise is recorded in detail, so as to reduce difficulty in follow-up investigation on a root cause of defective products, and further to accurately locate the defective products and related batches, improving the ability of risk management and control. Delivery information about each produce is recorded, it is helpful to find all products in the same batch as one product by means of this product, so as to facilitate the risk management and control over defective products, and also facilitate tracing of a problem, so as to reduce a probability of a subsequent problem.

Further, the vehicle condition analysis module includes a driving data obtaining module, a product package quality obtaining module and an influence analysis module and is configured to obtain a relation between package quality of a fresh milk product and a vehicle driving state by analyzing historical data, the driving data obtaining module is configured to record each turning angle Aᵢ of a vehicle and an initial emergency brake speed Dₕ of the vehicle during driving of the transportation vehicle by using big data, the product package quality obtaining module is configured to obtain a probability F that a defective product occurs during transportation of a product package, and the influence analysis module is configured to analyze a relation between the probability F that a defective product occurs and each turning angle Aᵢ of the vehicle as well as the initial emergency brake speed Dₕ of the vehicle according to a formula:

$$F = ( \frac{1}{n} {\sum }_{i = 1}^{n} J \frac{{A}_{i} - B}{180 - β} + \frac{1}{m} {\sum }_{h = 1}^{m} K \frac{{D}_{h} - γ}{100 - γ} ) \% ,$$

where
J is a weight of an influence of turning of the vehicle on a product, K is a weight of an influence of the emergency brake of the vehicle on the product, β is a minimum threshold of influence of the turning angle of the vehicle on the product, γ is a minimum threshold of influence of the initial emergency brake speed of the vehicle on the product, 180 is a maximum turning angle of the vehicle in normal driving, and 100 is a maximum driving speed of the vehicle in normal driving; and
the weight J of an influence of turning of the vehicle on a product and the weight K of an influence of an emergency brake of the vehicle on the product are determined as follows:
S1: taking each turning angle Aᵢ of the vehicle as a first feature value, taking the initial emergency brake speed Dₕ of the vehicle as a second feature value, and obtaining a first feature value and a second feature value of Lth transportation by means of a crawler obtaining tool;
S2: normalizing all the feature values:

$${x}_{i j} = \frac{{x}_{ij} - min \{ {x}_{1 j} , … , {x}_{L j} \}}{max \{ {x}_{1 j} , … , {x}_{L j} \} - min \{ {x}_{1 j} , … , {x}_{L j} \}} ,$$

where
xᵢⱼ is a jth feature value of ith transportation, i≤L, and j=1, 2;
S3: computing a proportion pᵢⱼ of the feature value of the ith transportation in the jth feature value

$${p}_{ij} = \frac{{x}_{ij}}{{\sum }_{i = 1}^{L} {x}_{ij}} ;$$

S4: computing an entropy value eⱼ of the jth feature value:

eⱼ=−kΣᵢ₌₁^{L}pᵢⱼ ln pᵢⱼ, where

k=1/ln(L)>0;
S5: computing an information entropy redundancy degree dⱼ

dⱼ=1−eⱼ;
S6: computing a weight wⱼ of each feature value:

$${w}_{j} = \frac{{d}_{j}}{{\sum }_{j = 1}^{2} {d}_{j}} ;$$

and
S7: assigning a value to the weight J of an influence of turning of the vehicle on a product, and assigning a value to the weight K of an influence of an emergency brake of the vehicle on the product. Statistics and analysis are performed on a relation between a driving condition of a vehicle and product quality, so as to effectively select a safer and faster transportation route, reduce a transportation loss and improve benefits of local fresh milk products.

Further, the data decryption module includes an encryption information reading module, a node decryption module and a hash comparison module; the encryption information reading module is configured to obtain corresponding node encryption information according to a code Cₙ of information to be read; the node decryption module is configured to decode the node encryption information by means of a private key in the module matching a system public key and obtain an original hash character string according to a node position obtained by decoding; the hash comparison module obtains corresponding data in the database according to the code Cₙ of the information to be read, converts the data into a hash character string, compares the hash character string with the original hash character string, determines that the data in the database is not falsified in response to determining that the hash character string is consistent with the original hash character string, and determines that the data in the database is falsified and send the data to a supervisor to remind the supervisor for inspection in response to determining that hash character string is inconsistent with the original hash character string; and the data analysis module is configured to analyze the data stored in the database, and specifically analyze production and processing data on a produced fresh milk product according to a time and a place, and analyze each quality index Oₙ of fresh milk products produced in different regions. According to different classification modes, production data and processing data of fresh milk in a province are analyzed, and quality indexes of the fresh milk in the province are analyzed, so as to effectively obtain problems of fresh milk industry and a subsequent development direction by means of analysis.

Compared with the prior art, the present disclosure has the beneficial effects that by means of information collection and storage of an entire process of fresh milk from production to delivery, it is guaranteed that when problems occur, all products related to a defective product in an entire production chain can be traced by means of data of the defective product, to ensure that hazardous products can be recalled timely; by means of encryption of all the data, authenticity and validness of all data are guaranteed, illegal personnel are prevented from falsifying the data, the possibility that problems of a product caused by data falsification cannot be measured timely is reduced, and the security of products is improved.

### BRIEF DESCRIPTION OF THE DRAWINGS

The accompanying drawings are intended to provide a further understanding of the present disclosure, constitute a part of the specification, and are intended to explain the present disclosure together with the embodiments of the present disclosure, which do not constitute a limitation to the present disclosure. In the drawings:

FIG. 1 is a schematic structural diagram of an information-based intelligent quality traceability system for fresh milk according to the present disclosure;

FIG. 2 is a schematic structural diagram of a data encryption module of an information-based intelligent quality traceability system for fresh milk according to the present disclosure;

FIG. 3 is a schematic structural diagram of a data decryption module of an information-based intelligent quality traceability system for fresh milk according to the present disclosure;

FIG. 4 is a schematic structural diagram of a vehicle condition analysis module of an information-based intelligent quality traceability system for fresh milk according to the present disclosure; and

FIG. 5 is a schematic diagram of steps of weight computation of vehicle condition analysis of an information-based intelligent quality traceability system for fresh milk according to the present disclosure.

### DETAILED DESCRIPTION OF THE EMBODIMENTS

The technical solutions of the embodiments of the present disclosure are clearly and completely described below with reference to the drawings. Apparently, the described embodiments are merely some embodiments rather than all embodiments of the present disclosure. All other embodiments obtained by a person of ordinary skill in the art based on the embodiments of the present disclosure without creative efforts shall fall within the protection scope of the present disclosure.

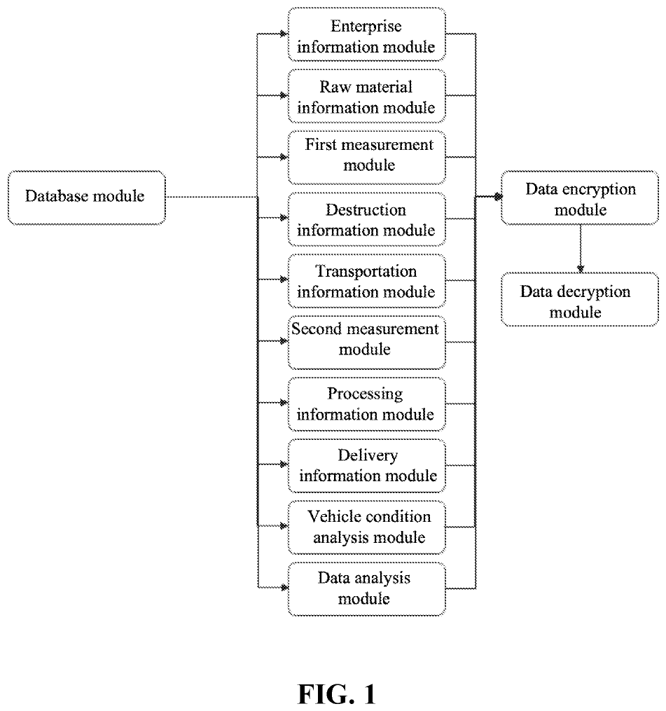

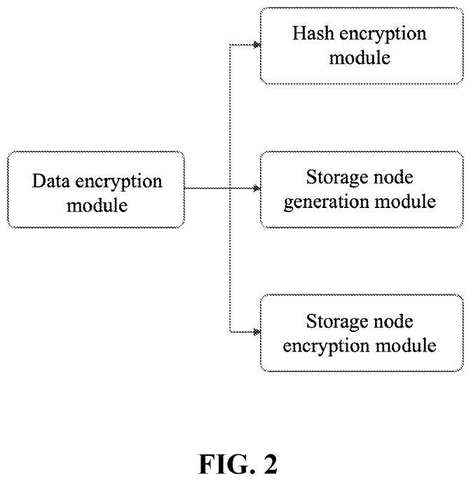

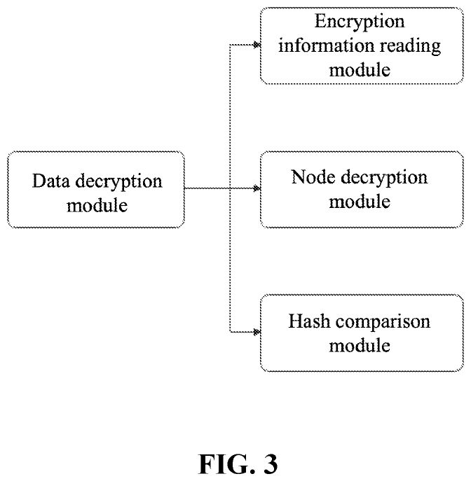

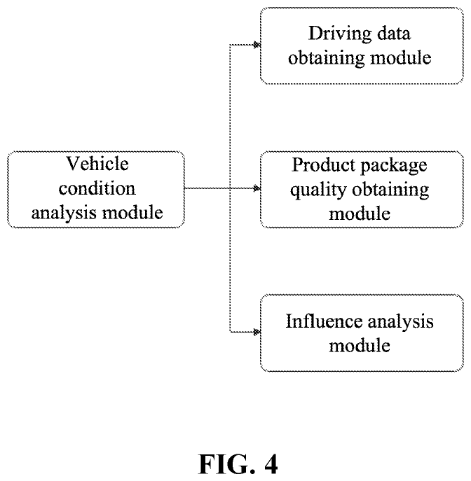

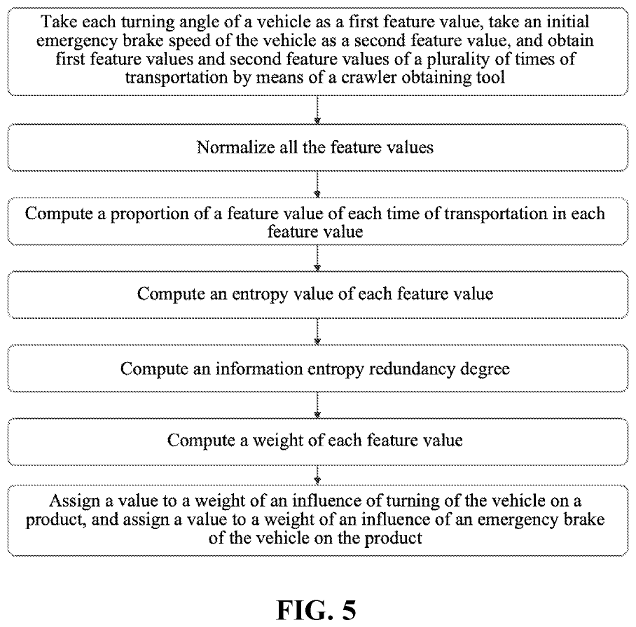

With reference to FIGS. 1-5, the present disclosure provides a technical solution: an information-based intelligent quality traceability system for fresh milk includes a database module, a data encryption module, an enterprise information module, a raw material information module, a first measurement module, a destruction information module, a transportation information module, a second measurement module, a processing information module, a delivery information module, a vehicle condition analysis module, a data decryption module and a data analysis module. The database module is configured to store all data in the system. The data encryption module is configured to encrypt the data generated in the system. The raw material information module is configured to obtain information about raw fresh milk produced daily. The enterprise information module is configured to obtain information about a farm and an individual household. The first measurement module is configured to measure fresh milk conveyed from the farm and the individual household daily. The destruction information module is configured to obtain information about fresh milk that does not comply with national standards during first measurement. The transportation information module is configured to obtain transportation information about a milk tanker. The second measurement module is configured to measure fresh milk transported to a dairy processing enterprise. The processing information module is configured to obtain data on processing of the fresh milk by the dairy processing enterprise. The delivery information module is configured to obtain data of processed milk after delivery. The vehicle condition analysis module is configured to analyze a road driving condition of a vehicle. The data decryption module is configured to inspect encrypted information. The data analysis module is configured to analyze data in a database.

The data encryption module includes a hash encryption module, a storage node generation module and a storage node encryption module. The hash encryption module is configured to generate an original hash character string corresponding to data generated in each module. The storage node generation module is configured to generate a random node position for storing the original hash character string when the original hash character string is generated. The storage node encryption module is configured to encrypt the node position for storing the original hash character string by means of a built-in public key of the system, and store node encryption information in the database.

The enterprise information module is configured to obtain production license information, business license information and production scale information about each farm and individual household, store the information in the database, match a time limit of each license with a system time, mark an enterprise which has an expired and invalid license, warn a supervisor, simultaneously generate an enterprise information code C₁, where node encryption information about enterprise information about the farm and the individual household is directly obtained by means of the enterprise information code C₁.

The raw material information module is configured to obtain the information about raw fresh milk produced daily including a source of production of a batch of raw milk A, a production time of the raw milk A, and quality of the raw milk A, store the information in the database, and simultaneously generate a raw material information code C₂, where node encryption information about the information about the raw milk A is directly obtained by means of the raw material information code C₂, and the raw milk A is any batch of raw milk.

The first measurement module is configured to measure each quality index Oₙ of raw milk A and compare each quality index Oₙ of the raw milk A with a national standard index Iₙ. When each quality index Oₙ of the raw milk A complies with the national standard Iₙ, the raw milk A is allowed to be transported out from a production place, each quality index is stored in a database, a first measurement information code C₃ is simultaneously generated, where node encryption information about each quality index Oₙ of the raw milk A is directly obtained by means of the first measurement information code C₃.

In the embodiment, quality indexes Oₙ of a batch of raw milk are as follows: protein measurement value O₁=2.9, fat measurement value O₂=3.1, microorganism measurement value O₃=189, freezing point measurement value O₄=−0.52, relative density measurement value O₅=1.035, non-fat milk solid measurement value O₆=8.1, acidity measurement value O₇=13, and adulteration measurement value O₈=0. This batch of raw milk complies with the national standards and can be transported out of a production place.

The destruction information module is configured to obtain each quality index Oₙ of raw milk B with a quality index Oₙ not complying with the national standard Iₙ, a destruction mode of the raw milk B, and a destruction place of the raw milk B, store destruction information in the database, send the destruction information to a supervisor to remind the supervisor to supervise a destruction process, and simultaneously generate a destruction information code C_{d}, where node encryption information about each quality index Oₙ of the raw milk B, the destruction mode of the raw milk B and the destruction place of the raw milk B is directly obtained by means of the destruction information code C_{d}, and the raw milk B is any batch of raw milk with unqualified quality indexes. The transportation information module is configured to obtain transportation information about the raw milk A during transportation from a production place to a processing enterprise, including vehicle information, driver information, vehicle positioning, a milk tank temperature and starting and ending times of transportation, store the transportation information about the raw milk A in the database, and simultaneously generate a transportation information code C₄, where the transportation information about the raw milk A from the database is directly obtained by means of the transportation information code C₄.

The second measurement module is configured to measure each quality index Oₙ of the raw milk A and compare each quality index Oₙ of the raw milk A with a national standard index Iₙ. When each quality index Oₙ of the raw milk A complies with the national standard Iₙ, the raw milk A is allowed to enter the processing enterprise from a transport vehicle, each quality index is stored in the database, a second measurement information code C₅ is simultaneously generated, where node encryption information about each quality index Oₙ of the raw milk A is directly obtained by means of the second measurement information code C₅.

In the embodiment, quality indexes Oₙ of a batch of raw milk are as follows: protein measurement value O₁=2.6, fat measurement value O₂=3.1, microorganism measurement value O₃=188, freezing point measurement value O₄=−0.51, relative density measurement value O₅=1.034, non-fat milk solid measurement value O₆=8.2, acidity measurement value O₇=14, and adulteration measurement value O₈=0. This batch of raw milk does not comply with the national standards and needs to be destroyed, and a supervisor is asked for supervision.

The processing information module is configured to obtain processing information about raw milk A in a processing enterprise, including a processing time, a processing temperature, a processing apparatus and a processing batch, store the processing information in the database, and simultaneously generate a processing information code C₆, where node encryption information about the processing information about the raw milk A is directly obtained by means of the processing information code C₆. The delivery information module is configured to obtain delivery information about each product obtained after the raw milk A is processed in the processing enterprise, including a delivery time, a delivery batch, a delivery transportation direction and a number of products, store the delivery information in the database, and simultaneously generate a delivery information code C₇ for each product obtained after the raw milk A is processed, where node encryption information about the delivery information about each product obtained after the raw milk A is processed in the processing enterprise is directly obtained by means of the factory information code C₇.

The vehicle condition analysis module includes a driving data obtaining module, a product package quality obtaining module and an influence analysis module and is configured to obtain a relation between package quality of a fresh milk product and a vehicle driving state by analyzing historical data. The driving data obtaining module is configured to record each turning angle Aᵢ of a vehicle and an initial emergency brake speed Dₕ of the vehicle during driving of the transportation vehicle by using big data. The product package quality obtaining module is configured to obtain a probability F that a defective product occurs during transportation of a product package. The influence analysis module is configured to analyze a relation between the probability F that a defective product occurs and each turning angle Aᵢ of the vehicle as well as the initial emergency brake speed Dₕ of the vehicle according to a formula:

$$F = ( \frac{1}{n} {\sum }_{i = 1}^{n} J \frac{{A}_{i} - B}{180 - β} + \frac{1}{m} {\sum }_{h = 1}^{m} K \frac{{D}_{h} - γ}{100 - γ} ) \% ,$$

where
J is a weight of an influence of turning of the vehicle on a product, K is a weight of an influence of an emergency brake of the vehicle on the product, β is a minimum threshold of an influence of the turning angle of the vehicle on the product, and γ is a minimum threshold of an influence of the initial emergency brake speed of the vehicle on the product.

The weight J of an influence of turning of the vehicle on a product and the weight K of an influence of an emergency brake of the vehicle on the product are determined as follows:
S1: take each turning angle Aᵢ of the vehicle as a first feature value, take the initial emergency brake speed Dₕ of the vehicle as a second feature value, and obtain a first feature value and a second feature value of Lth transportation by means of a crawler obtaining tool;
S2: normalize all the feature values:

$${x}_{i j} = \frac{{x}_{ij} - min \{ {x}_{1 j} , … , {x}_{L j} \}}{max \{ {x}_{1 j} , … , {x}_{L j} \} - min \{ {x}_{1 j} , … , {x}_{L j} \}} ,$$

where
xᵢⱼ is a jth feature value of ith transportation, i≤L, and j=1, 2;
S3: compute a proportion pᵢⱼ of the feature value of the ith transportation in the jth feature value

$${p}_{ij} = \frac{{x}_{ij}}{{\sum }_{i = 1}^{L} {x}_{ij}} ;$$

S4: compute an entropy value eⱼ of the jth feature value:

eⱼ=−kΣᵢ₌₁^{L}pᵢⱼ ln pᵢⱼ, where

k=1/ln(L)>0;
S5: compute an information entropy redundancy degree dⱼ

dⱼ=1−eⱼ;
S6: compute a weight wⱼ of each feature value:

$${w}_{j} = \frac{{d}_{j}}{{\sum }_{j = 1}^{2} {d}_{j}} ;$$

and
S7: assign a value to the weight J of an influence of turning of the vehicle on a product, and assign a value to the weight K of an influence of an emergency brake of the vehicle on the product.

In the embodiment, the minimum threshold β where the turning angle of the vehicle influences the product is set to be 90, and the minimum threshold γ where the initial emergency brake speed of the vehicle influences the product is set to be 60.

$$m = 5 , n = 5 , {x}_{11} = 90 , {x}_{21} = 120 , {x}_{31} = 180 , {x}_{41} = 90 , and$$

$${x}_{51} = 180. {p}_{11} = 0 , {p}_{21} = \frac{1}{3} , {p}_{31} = 1 , {p}_{41} = 0 and {p}_{51} = 1$$

are obtained by means of computation. The first feature value e₁=0.625, the information entropy redundancy degree d₁=0.375, the second feature value e₂=0.616, information entropy redundancy degree d₂=0.384, the weight of the first feature value is that w₁=0.49, and the weight of the second feature value is that w₂=0.51, such that a value of 0.49 is assigned to the weight J of an influence of turning of the vehicle on a product, a value of 0.51 is assigned to the weight K of an influence of the emergency brake of the vehicle on the product, and a probability that product package has a defective product in this transportation is that F=0.96%.

The data decryption module includes an encryption information reading module, a node decryption module and a hash comparison module. The encryption information reading module is configured to obtain corresponding node encryption information according to a code Cₙ of information to be read. The node decryption module is configured to decode the node encryption information by means of a private key in the module matching a system public key and obtain an original hash character string according to a node position obtained by decoding. The hash comparison module obtains corresponding data in the database according to the code Cₙ of the information to be read, converts the data into a hash character string, compares the hash character string with the original hash character string, determines that the data in the database is not falsified in response to determining that the hash character string is consistent with the original hash character string, and determines that the data in the database is falsified and send the data to a supervisor to remind the supervisor for inspection in response to determining that hash character string is inconsistent with the original hash character string. The data analysis module is configured to analyze the data stored in the database, and specifically analyze production and processing data on a produced fresh milk product according to a time and a place, and analyze each quality index Oₙ of fresh milk products produced in different regions.

It should be noted that relational terms herein such as first and second are merely used to distinguish one entity or operation from another entity or operation without necessarily requiring or implying any actual such relationship or order between such entities or operations. In addition, terms “include”, “comprise”, or their any other variations are intended to cover a non-exclusive inclusion, so that a process, a method, an article, or a device including a series of elements not only includes those elements, but also includes other elements that are not explicitly listed, or also includes inherent elements of the process, the method, the article, or the device.

Finally, it should be noted that the above descriptions are only preferred embodiments of the present disclosure, and are not intended to limit the present disclosure. Although the present disclosure has been described in detail with reference to the foregoing embodiments, those skilled in the art may still modify the technical solutions described in the foregoing embodiments, or equivalently substitute some technical features thereof. Any modifications, equivalent substitutions, improvements, etc. made within the spirit and scope of the present disclosure should be included within the protection scope of the present disclosure.

What is claimed is:

1. An information-based intelligent quality traceability system for fresh milk, comprising a database module, a data encryption module, an enterprise information module, a raw material information module, a first measurement module, a destruction information module, a transportation information module, a second measurement module, a processing information module, a delivery information module, a vehicle condition analysis module, a data decryption module and a data analysis module, wherein the database module is configured to store all data of the system; the data encryption module is configured to encrypt the data generated in the system; the raw material information module is configured to obtain information about raw fresh milk produced daily; the enterprise information module is configured to obtain information about a farm and an individual household; the first measurement module is configured to measure fresh milk conveyed from the farm and the individual household daily; the destruction information module is configured to obtain information about fresh milk that does not comply with national standards during first measurement; the transportation information module is configured to obtain transportation information about a milk tanker; the second measurement module is configured to measure fresh milk transported to a dairy processing enterprise; the processing information module is configured to obtain data on processing of the fresh milk by the dairy processing enterprise; the delivery information module is configured to obtain data of processed milk after delivery; the vehicle condition analysis module is configured to analyze a road driving condition of a vehicle; the data decryption module is configured to inspect encrypted information; and the data analysis module is configured to analyze data in a database.

2. The information-based intelligent quality traceability system for fresh milk according to claim 1, wherein the data encryption module comprises a hash encryption module, a storage node generation module and a storage node encryption module; the hash encryption module is configured to generate an original hash character string corresponding to data generated in each module; the storage node generation module is configured to generate a random node position for storing the original hash character string when the original hash character string is generated; and the storage node encryption module is configured to encrypt the node position for storing the original hash character string by means of a built-in public key of the system, and store node encryption information in the database.

3. The information-based intelligent quality traceability system for fresh milk according to claim 1, wherein the enterprise information module is configured to obtain production license information, business license information and production scale information about each farm and individual household, store the information in the database, match a time limit of each license with a system time, mark an enterprise which has an expired and invalid license, warn a supervisor, and simultaneously generate an enterprise information code C₁, wherein node encryption information about enterprise information about the farm and the individual household is directly obtained by means of the enterprise information code C₁.

4. The information-based intelligent quality traceability system for fresh milk according to claim 1, wherein the raw material information module is configured to obtain the information about raw fresh milk produced daily, comprising a source of production of a batch of raw milk A, a production time of the raw milk A, and quality of the raw milk A, store the information in the database, and simultaneously generate a raw material information code C₂ wherein node encryption information about the information about the raw milk A is directly obtained by means of the raw material information code C₂, and the raw milk A is any batch of raw milk.

5. The information-based intelligent quality traceability system for fresh milk according to claim 1, wherein the first measurement module is configured to measure each quality index Oₙ of raw milk A and compare each quality index Oₙ of the raw milk A with a national standard index Iₙ; and when each quality index Oₙ of the raw milk A complies with the national standard Iₙ, the raw milk A is allowed to be transported out from a production place, each quality index is stored in a database, a first measurement information code C₃ is simultaneously generated, and node encryption information about each quality index Oₙ of the raw milk A is directly obtained by means of the first measurement information code C₃.

6. The information-based intelligent quality traceability system for fresh milk according to claim 5, wherein the destruction information module is configured to obtain each quality index Oₙ of raw milk B with a quality index Oₙ not complying with the national standard Iₙ, a destruction mode of the raw milk B, and a destruction place of the raw milk B, store destruction information in the database, send the destruction information to a supervisor to remind the supervisor to supervise a destruction process, and simultaneously generate a destruction information code C_{d}, wherein node encryption information about each quality index Oₙ of the raw milk B, the destruction mode of the raw milk B and the destruction place of the raw milk B is directly obtained by means of the destruction information code C_{d}, and the raw milk B is any batch of raw milk with unqualified quality indexes; and the transportation information module is configured to obtain transportation information about the raw milk A during transportation from a production place to a processing enterprise, comprising vehicle information, driver information, vehicle positioning, a milk tank temperature and starting and ending times of transportation, store the transportation information about the raw milk A in the database, and simultaneously generate a transportation information code C₄, wherein the transportation information about the raw milk A from the database is directly obtained by means of the transportation information code C₄.

7. The information-based intelligent quality traceability system for fresh milk according to claim 1, wherein the second measurement module is configured to measure each quality index Oₙ of a raw milk A and compare each quality index Oₙ of the raw milk A with a national standard index Iₙ; and when each quality index Oₙ of the raw milk A complies with the national standard Iₙ, the raw milk A is allowed to enter the processing enterprise from a transport vehicle, each quality index is stored in the database, a second measurement information code C₅ is simultaneously generated, and node encryption information about each quality index Oₙ of the raw milk A is directly obtained by means of the second measurement information code C₅.

8. The information-based intelligent quality traceability system for fresh milk according to claim 1, wherein the processing information module is configured to obtain processing information about raw milk A in a processing enterprise, comprising a processing time, a processing temperature, a processing apparatus and a processing batch, store the processing information in the database, and simultaneously generate a processing information code C₆, wherein node encryption information about the processing information about the raw milk A is directly obtained by means of the processing information code C₆; and the delivery information module is configured to obtain delivery information about each product obtained after the raw milk A is processed in the processing enterprise, comprising a delivery time, a delivery batch, a delivery transportation direction and a number of products, and store the delivery information in the database, and simultaneously generate a delivery information code C₇ for each product obtained after the raw milk A is processed, wherein node encryption information about the delivery information about each product obtained after the raw milk A is processed in the processing enterprise is directly obtained by means of a factory information code C₇.

9. The information-based intelligent quality traceability system for fresh milk according to claim 1, wherein the vehicle condition analysis module comprises a driving data obtaining module, a product package quality obtaining module and an influence analysis module and is configured to obtain a relation between package quality of a fresh milk product and a vehicle driving state by analyzing historical data; the driving data obtaining module is configured to record each turning angle Aᵢ of a vehicle and an initial emergency brake speed Dₕ of the vehicle during driving of the transportation vehicle by using big data; the product package quality obtaining module is configured to obtain a probability F that a defective product occurs during transportation of a product package; and the influence analysis module is configured to analyze a relation between the probability F that a defective product occurs and each turning angle Aᵢ of the vehicle as well as the initial emergency brake speed Dₕ of the vehicle according to a formula:
$$F = ( \frac{1}{n} {\sum }_{i = 1}^{n} J \frac{{A}_{i} - B}{180 - β} + \frac{1}{m} {\sum }_{h = 1}^{m} K \frac{{D}_{h} - γ}{100 - γ} ) \% ,$$
wherein
J is a weight of an influence of turning of the vehicle on a product, K is a weight of an influence of an emergency brake of the vehicle on the product, β is a minimum threshold of an influence of the turning angle of the vehicle on the product, and γ is a minimum threshold of an influence of the initial emergency brake speed of the vehicle on the product; and
the weight J of an influence of turning of the vehicle on a product and the weight K of an influence of an emergency brake of the vehicle on the product are determined as follows:
S1: taking each turning angle Aᵢ of the vehicle as a first feature value, taking the initial emergency brake speed Dₕ of the vehicle as a second feature value, and obtaining a first feature value and a second feature value of Lth transportation by means of a crawler obtaining tool;
S2: normalizing all the feature values:
$${x}_{i j} = \frac{{x}_{ij} - min \{ {x}_{1 j} , … , {x}_{L j} \}}{max \{ {x}_{1 j} , … , {x}_{L j} \} - min \{ {x}_{1 j} , … , {x}_{L j} \}} ,$$
wherein
xᵢⱼ is a jth feature value of ith transportation, i≤L, and j=1, 2;
S3: computing a proportion pᵢⱼ of the feature value of the ith transportation in the jth feature value
$${p}_{ij} = \frac{{x}_{ij}}{{\sum }_{i = 1}^{L} {x}_{ij}} ;$$
S4: computing an entropy value eⱼ of the jth feature value:
eⱼ=−kΣᵢ₌₁^{L}pᵢⱼ ln pᵢⱼ, wherein
k=1/ln(L)>0;
S5: computing an information entropy redundancy degree dⱼ
dⱼ=1−eⱼ;
S6: computing a weight wⱼ of each feature value:
$${w}_{j} = \frac{{d}_{j}}{{\sum }_{j = 1}^{2} {d}_{j}} ;$$
and
S7: assigning a value to the weight J of an influence of turning of the vehicle on a product, and assigning a value to the weight K of an influence of an emergency brake of the vehicle on the product.

10. The information-based intelligent quality traceability system for fresh milk according to claim 1, wherein the data decryption module comprises an encryption information reading module, a node decryption module and a hash comparison module; the encryption information reading module is configured to obtain corresponding node encryption information according to a code Cₙ of information to be read; the node decryption module is configured to decode the node encryption information by means of a private key in the module matching a system public key and obtain an original hash character string according to a node position obtained by decoding; the hash comparison module obtains corresponding data in the database according to the code Cₙ of the information to be read, converts the data into a hash character string, compares the hash character string with the original hash character string, determines that the data in the database is not falsified in response to determining that the hash character string is consistent with the original hash character string, and determines that the data in the database is falsified and send the data to a supervisor to remind the supervisor for inspection in response to determining that hash character string is inconsistent with the original hash character string; and the data analysis module is configured to analyze the data stored in the database, and specifically analyze production and processing data on a produced fresh milk product according to a time and a place, and analyze each quality index Oₙ of fresh milk products produced in different regions.
